(19) United States
(12) Patent Application Publication
(10) Pub. No.: US 2016/0343025 A1
(43) Pub. Date: Nov. 24, 2016

(54) SYSTEMS, METHODS, AND DEVICES FOR DATA QUALITY ASSESSMENT

(71) Applicant: Turn Inc., Redwood City, CA (US)

(72) Inventors: Jianqiang Shen, Redwood City, CA (US); Ali Dasdan, Redwood City, CA (US)

(73) Assignee: Turn Inc., Redwood City, CA (US)

(21) Appl. No.: 14/714,975

(22) Filed: May 18, 2015

(51) Int. Cl. G06Q 30/02; G06F 17/30

(52) U.S. Cl. CPC G06Q 30/0242; G06F 17/30598; G06Q 30/0254; G06Q 30/0273

(57) ABSTRACT

Disclosed herein are systems, methods, and devices for data quality assessment. Systems include a data aggregator configured to receive third party data and reference data. Third party data characterizes a first plurality of values for a first plurality of data categories associated with users identified based on a first online advertisement campaign. Reference data characterizes a second plurality of values for a second plurality of data categories associated with the users. Systems further include a quality assessment metric generator configured to determine probability metrics based on a comparison of the third party data and the reference data, each probability metric characterizing an accuracy of a third party data provider for each association between a user and a data category identified by the third party data provider. The quality assessment metric generator is further configured to generate a quality assessment metric characterizing an overall accuracy of the third party data provider.

### TECHNICAL FIELD

This disclosure generally relates to online advertising, and more specifically to assessing a quality of data associated with online advertising.

### BACKGROUND

In online advertising, Internet users are presented with advertisements as they browse the Internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single Internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Disclosed herein are systems, methods, and devices for data quality assessment. In various embodiments, the systems may include a data aggregator configured to receive third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign. The systems may further include a quality assessment metric generator configured to determine a plurality of probability metrics based on a comparison of the third party data and the reference data, each probability metric of the plurality of probability metrics characterizing an accuracy of the third party data provider for each association between a user and a data category identified by the third party data provider, the quality assessment metric generator being further configured to generate at least one quality assessment metric characterizing an overall accuracy of the third party data provider, the at least one quality assessment metric being generated based on a combination of at least some of the plurality of probability metrics.

In some embodiments, the plurality of probability metrics include estimated conditional probabilities that each characterize a probability that a user is identified by the reference data provider as not having a value given that the user has been identified as having the value by the third party data provider. The plurality of probability metrics may include an estimated conditional probability for each value of each data category included in the first plurality of data categories. In some embodiments, at least one quality assessment metric is a weighted sum of the plurality of probability metrics. In various embodiments, the weighted sum includes a plurality of weights, wherein each weight of the plurality of weights is determined based on a number of possible values for each data category and a designated weight coefficient. In some embodiments, the quality assessment metric generator is further configured to generate the plurality of probability metrics based on targeting criteria for a second online advertisement campaign, where the second online advertisement campaign is different from the first online advertisement campaign.

In various embodiments, the quality assessment metric generator is configured to generate the plurality of probability metrics by identifying a plurality of differences between a first probability distribution of the third party data and a second probability distribution of the reference data. In various embodiments, each probability metric of the plurality of probability metrics characterizes a difference between a probability associated with a value of a data category identified by the third party data provider and a probability associated with a value of a data category identified by the reference data provider. Moreover, the at least one quality assessment metric may be a weighted sum of the plurality of probability metrics. In various embodiments, the quality assessment metric generator is further configured to generate a plurality of price recommendations based on the at least one quality assessment metric, where each price recommendation identifies a recommended price associated with the third party data. In some embodiments, the quality assessment metric generator is further configured to generate a third party data provider recommendation based on the at least one quality assessment metric, the third party data provider recommendation identifying a recommended third party data provider associated with a third online advertisement campaign.

Also disclosed herein are systems that may include at least a first processing node configured to receive third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign. The systems may also include at least a second processing node configured to determine a plurality of probability metrics based on a comparison of the third party data and the reference data, each probability metric of the plurality of probability metrics characterizing an accuracy of the third party data provider for each association between a user and a data category identified by the third party data provider, the second processing node being further configured to generate at least one quality assessment metric characterizing an overall accuracy of the third party data provider, the at least one quality assessment metric being generated based on a combination of at least some of the plurality of probability metrics.

In some embodiments, the plurality of probability metrics include estimated conditional probabilities that each characterize a probability that a user is identified by the reference data provider as not having a value given that the user has been identified as having the value by the third party data provider. In various embodiments, the plurality of probability metrics include an estimated conditional probability for each value of each data category included in the first plurality of data categories. In some embodiments, the at least one quality assessment metric is a weighted sum of the plurality of probability metrics, wherein the weighted sum includes a plurality of weights, and wherein each weight of the plurality of weights is determined based on a number of possible values for each data category and a designated weight coefficient. In various embodiments, the second processing node is configured to generate the plurality of probability metrics by identifying a plurality of differences between a first probability distribution of the third party data and a second probability distribution of the reference data. According to various embodiments, each probability metric of the plurality of probability metrics characterizes a difference between a probability associated with a value of a data category identified by the third party data provider and a probability associated with a value of a data category identified by the reference data provider. Moreover, the at least one quality assessment metric may be a weighted sum of the plurality of probability metrics.

Further disclosed herein are one or more non-transitory computer readable media having instructions stored thereon for performing a method, the method including receiving third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign. The methods may also include determining a plurality of probability metrics based on a comparison of the third party data and the reference data, each probability metric of the plurality of probability metrics characterizing an accuracy of the third party data provider for each association between a user and a data category identified by the third party data provider. The methods may also include generating at least one quality assessment metric characterizing an overall accuracy of the third party data provider, the at least one quality assessment metric being generated based on a combination of at least some of the plurality of probability metrics.

In various embodiments, the plurality of probability metrics include estimated conditional probabilities that each characterize a probability that a user is identified by the reference data provider as not having a value given that the user has been identified as having the value by the third party data provider. In some embodiments, the generating of the plurality of probability metrics further includes identifying a plurality of differences between a first probability distribution of the third party data and a second probability distribution of the reference data. In various embodiments, the method further includes generating a plurality of price recommendations based on the at least one quality assessment metric, the price recommendation identifying a recommended price associated with the third party data. The methods may also include generating third party data provider recommendation based on the at least one quality assessment metric, the third party data provider recommendation identifying a recommended third party data provider associated with a third online advertisement campaign.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of an advertiser hierarchy, implemented in accordance with some embodiments.

FIG. 2 illustrates a diagram of an example of a system for generating a quality assessment metric for third party data, implemented in accordance with some embodiments.

FIG. 3 illustrates a flow chart of an example of a quality assessment metric generation method, implemented in accordance with some embodiments.

FIG. 4 illustrates a flow chart of an example of another quality assessment metric generation method, implemented in accordance with some embodiments.

FIG. 5 illustrates a flow chart of an example of yet another quality assessment metric generation method, implemented in accordance with some embodiments.

FIG. 6 illustrates a flow chart of an example of another quality assessment metric generation method, implemented in accordance with some embodiments.

FIG. 7 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, advertisers often try to provide the best ad for a given user in an online context. Advertisers often set constraints which affect the applicability of the advertisements. For example, an advertiser might try to target only users in a particular geographical area or region who may be visiting web pages of particular types for a specific campaign. Thus, an advertiser may try to configure a campaign to target a particular group of end users, which may be referred to herein as an audience. As used herein, a campaign may be an advertisement strategy which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser-defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid.

When implementing an online advertisement campaign across different websites, it is useful to know what the audience population, or group of users, that uses the website includes. For example, if an advertiser intends to target an audience that includes women, it is useful to be able to identify websites that have audiences primarily comprised of women. Utilizing such data about the website's audience may enable an online advertiser to efficiently select websites on which to advertise, and efficiently implement the online advertisement campaign in a way that reaches a large audience for a particular budget. As disclosed herein, data identifying or characterizing the audience or group of users that use a website may be an audience profile associated with that website. Moreover, such data may include data values that characterize or identify specific features of the users. For example, users may be associated with several data categories or tags which may each be specific to a particular feature or characteristic of the user. In one example, such a feature may be the user's gender. For each data category, a value may be stored that identifies the user's relationship with the data category. For example, for the data category “gender”, a value of “male” or “female” may be stored depending on whether or not the user is male or female. Thus a particular data category may have multiple possible values, and multiple data categories may be associated with a user.

An advertiser may access third party data to improve the effectiveness of targeting provided for online advertisement campaigns. For example, an increase of data about a population of users may increase the precision with which the online advertisement campaign may be targeted. As disclosed herein, third party data may include tags and labels associated with data categories for multiple Internet users. Moreover, third party data received from different third party data providers may label the same user differently. For example, for a particular Internet user, a first third party data provider such as DataLogix might label him/her as a 35-year-old man, and a second third party data provider such as Lotame might label him/her as a 40-year-old woman. To target an audience of users, the advertiser may use such third party data to obtain data about the users. For example, if an advertiser targets middle-age men, they may constrain the online advertisement campaign to those users marked by DataLogix as men that are 30 to 50 years old. However, the quality of the third party data providers might be significantly different, and the third party data provided by Lotame might actually be more accurate. Accordingly, with no standardized measurement or assessment of the third party data provider's respective qualities and accuracies the advertiser might not be able to determine which third party data should be used.

Various systems, methods, and devices disclosed herein provide efficient and low-cost assessment of a quality and accuracy of third party data received from third party data providers. The assessment of the third party data may be further used to determine a price associated with the third party data as well as which third party data providers should be used to implement a particular online advertisement campaign. In various embodiments, an online advertisement campaign may be implemented and various data events and users associated with the data events may be recorded. Third party data and reference data may be retrieved for each of the users. As disclosed herein, reference data may refer to data collected by a reference data provider which may be an independent survey agency or a “gold-standard” of data provider, such as The Nielsen Company. A probability distribution of the third party data may be compared with a probability distribution of the reference data. In various embodiments, quality assessment metrics may be generated based on the comparison. Accordingly, each third party data provider may be measured and assessed relative to the reference data to determine a quality and accuracy of each third party data provider. As will be discussed in greater detail below, the quality assessment metrics may be used to generate price recommendations and third party data provider recommendations, which may be utilized when implementing subsequent online advertisement campaigns.

Accordingly, various embodiments disclosed herein provide novel assessments of quality and accuracy of data underlying the implementation and analysis of online advertisement campaigns. Thus, received data may be used to generate various data objects characterizing quality assessment metrics as well as other data structures which may be used to increase the effectiveness of targeting for online advertisement campaigns. In this way, processing systems used to implement such analyses may be improved to implement online advertisement campaigns more effectively and to process underlying data faster. In various embodiments, the generation of probability metrics and quality assessment metrics enables processing systems to analyze and use third party data to target online advertisement campaigns in ways not previously possible. Moreover, embodiments disclosed herein enable processing systems to analyze data faster such that greater amounts of data may be analyzed and used within a particular operational window.

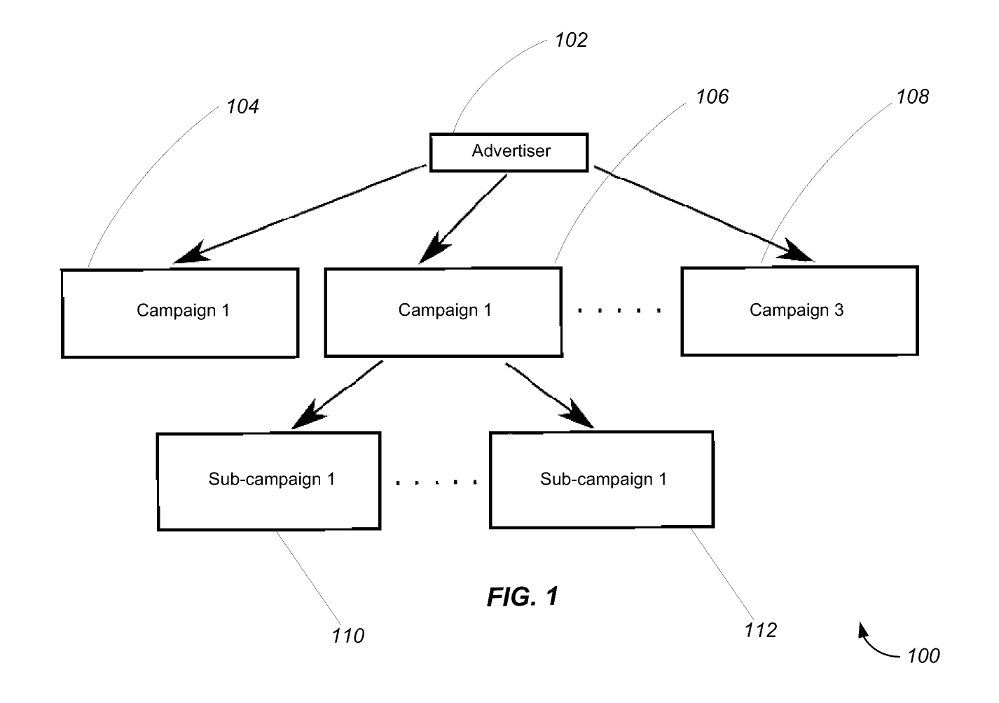

FIG. 1 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 102, may display or provide an advertisement to a user via a publisher, which may be a web site, a mobile application, or other browser or application capable of displaying online advertisements. The advertiser 102 may attempt to achieve the highest number of user actions for a particular amount of money spent, thus, maximizing the return on the amount of money spent. Accordingly, the advertiser 102 may create various different tactics or strategies to target different users. Such different tactics and/or strategies may be implemented as different advertisement campaigns, such as campaign 104, campaign 106, and campaign 108, and/or may be implemented within the same campaign. Each of the campaigns and their associated sub-campaigns may have different targeting rules which may be referred to herein as an audience segment. For example, a sports goods company may decide to set up a campaign, such as campaign 104, to show golf equipment advertisements to users above a certain age or income, while the advertiser may establish another campaign, such as campaign 106, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 110 may include one or more targeting rules that configure or direct the sub-campaign 110 towards an age group of 18-34 year old males that use a particular social media network, while the sub-campaign 112 may include one or more targeting rules that configure or direct the sub-campaign 112 towards female users of a particular mobile application. As similarly stated above, the sub-campaigns may also be referred to herein as line items.

Accordingly, an advertiser 102 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

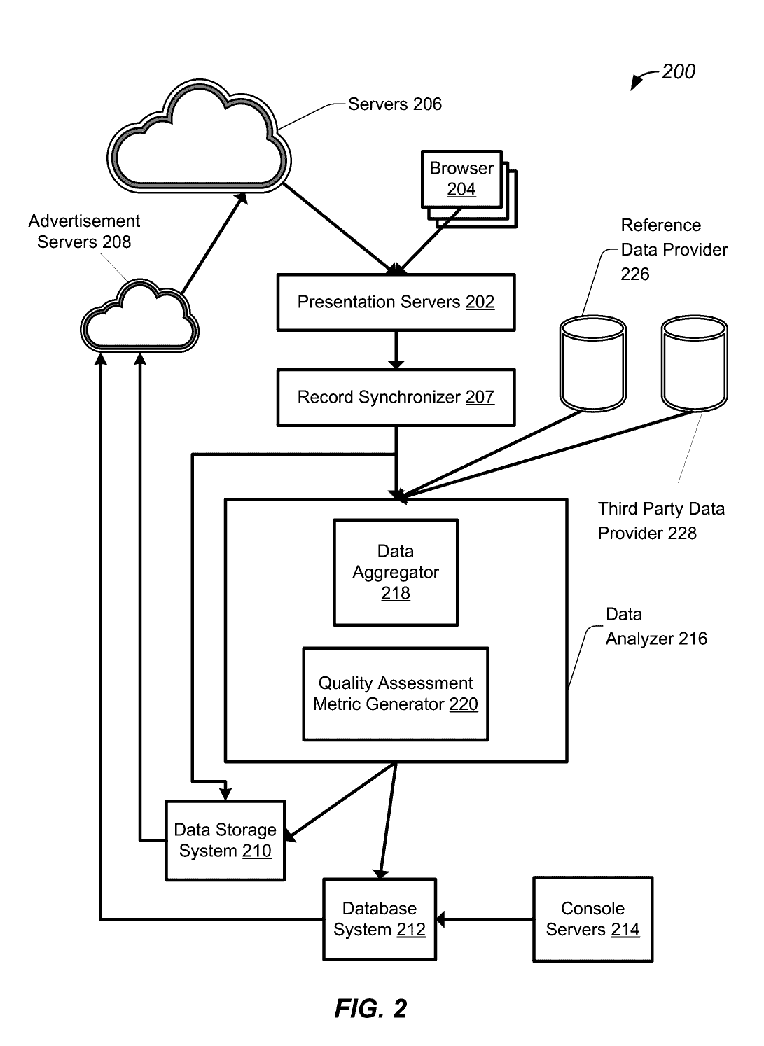

FIG. 2 illustrates a diagram of an example of a system for generating a quality assessment metric for third party data, implemented in accordance with some embodiments. A system, such as system 200, may be implemented to generate a quality assessment metric that characterizes an overall quality and accuracy of data received from a third party data provider. As will be discussed in greater detail below, system 200 may be configured to implement online advertisement campaigns, and provider one or more services to advertisers for which the online advertisement campaigns are implemented. For example, one or more components of system 200 may be configured to collect third party data and reference data and further configured to analyze probability distributions of the collected third party data and reference data to determine an overall quality of the third party data with respect to the reference data. As will be discussed in greater detail below, such quality assessment metrics may be used to generate recommendations of third party data providers to be used for online advertisement campaigns, as well as recommendations for pricing of such third party data.

In various embodiments, system 200 may include one or more presentation servers, such as presentation servers 202. According to some embodiments, presentation servers 202 may be configured to aggregate various online advertising data from several data sources. The online advertising data may include live Internet data traffic that may be associated with users, as well as variety of supporting tasks. For example, the online advertising data may include one or more data values identifying various impressions, clicks, data collection events, and/or beacon fires that may characterize interactions between users and one or more advertisement campaigns. As discussed herein, such data may also be described as performance data that may form the underlying basis of analyzing a performance of one or more advertisement campaigns. In some embodiments, presentation servers 202 may be front-end servers that may be configured to process a large number of real-Internet users, and associated SSL (Secure Socket Layer) handling. The front-end servers may be configured to generate and receive messages to communicate with other servers in system 200. In some embodiments, the front-end servers may be configured to perform logging of events that are periodically collected and sent to additional components of system 200 for further processing.

As similarly discussed above, presentation servers 202 may be communicatively coupled to one or more data sources such as browser 204 and servers 206. In some embodiments, browser 204 may be an Internet browser that may be running on a client machine associated with a user. Thus, a user may use browser 204 to access the Internet and receive advertisement content via browser 204. Accordingly, various clicks and other actions may be performed by the user via browser 204. Moreover, browser 204 may be configured to generate various online advertising data described above. For example, various cookies, advertisement identifiers, beacon fires, and user identifiers may be identified by browser 204 based on one or more user actions and may be transmitted to presentation servers 202 for further processing. As discussed above, various additional data sources may also be communicatively coupled with presentation servers 202 and may also be configured to transmit similar identifiers and online advertising data based on the implementation of one or more advertisement campaigns by various advertisement servers, such as advertisement servers 208 discussed in greater detail below. For example, the additional data servers may include servers 206, which may process bid requests and generate one or more data events associated with providing online advertisement content based on the bid requests. Thus, servers 206 may be configured to generate data events characterizing the processing of bid requests and implementation of an advertisement campaign. Such bid requests may be transmitted to presentation servers 202.

In various embodiments, system 200 may further include record synchronizer 207 which may be configured to receive one or more records from various data sources that characterize the user actions and data events described above. In some embodiments, the records may be log files that include one or more data values characterizing the substance of the user action or data event, such as a click or conversion. The data values may also characterize metadata associated with the user action or data event, such as a timestamp identifying when the user action or data event took place. According to various embodiments, record synchronizer 207 may be further configured to transfer the received records, which may be log files, from various end points, such as presentation servers 202, browser 204, and servers 206 described above, to a data storage system, such as data storage system 210 or database system 212 described in greater detail below. Accordingly, record synchronizer 207 may be configured to handle the transfer of log files from various end points located at different locations throughout the world to data storage system 210 as well as other components of system 200, such as data analyzer 216 discussed in greater detail below. In some embodiments, record synchronizer 207 may be configured and implemented as a MapReduce system that is configured to implement a MapReduce job to directly communicate with a communications port of each respective endpoint and periodically download new log files.

As discussed above, system 200 may further include advertisement servers 208 which may be configured to implement one or more advertisement operations. For example, advertisement servers 208 may be configured to store budget data associated with one or more advertisement campaigns, and may be further configured to implement the one or more advertisement campaigns over a designated period of time. In some embodiments, the implementation of the advertisement campaign may include identifying actions or communications channels associated with users targeted by advertisement campaigns, placing bids for impression opportunities, and serving content upon winning a bid. In some embodiments, the content may be advertisement content, such as an Internet advertisement banner, which may be associated with a particular advertisement campaign. The terms “advertisement server” and “advertiser” are used herein generally to describe systems that may include a diverse and complex arrangement of systems and servers that work together to display an advertisement to a user's device. For instance, this system will generally include a plurality of servers and processing nodes for performing different tasks, such as bid management, bid exchange, advertisement and campaign creation, content publication, etc. Accordingly, advertisement servers 208 may be configured to generate one or more bid requests based on various advertisement campaign criteria. As discussed above, such bid requests may be transmitted to servers 206.

In various embodiments, system 200 may include data analyzer 216 which may be configured to aggregate data from various data sources, such as third party data provider 228 and reference data provider 226. Data analyzer 216 may be further configured to generate quality assessment metrics that characterize a quality and accuracy of data retrieved from third party data provider 228. Accordingly, data analyzer 216 may include data aggregator 218 which may be configured to retrieve third party data from third party data providers, such as third party data provider 228. Data aggregator 218 may be further configured to retrieve reference data from reference data providers, such as reference data provider 226. Accordingly, data aggregator 218 may be configured to identify users based on user identifiers included in data stored in data storage system 210 or database system 212 which may have been generated and stored during the implementation of an online advertisement campaign. In some embodiments, data aggregator 218 may receive data from advertisement servers 208 via record synchronizer 207. Data aggregator 218 may be configured to generate data queries based on the user identifiers, and may be further configured to send the queries to reference data provider 226 and third party data provider 228. In some embodiments, data aggregator 218 may be configured to map the user identifiers to a different user identifier domain. For example, data aggregator 218 may be configured to map user identifiers from an online advertisement service provider's user domain to provider user identifiers from a third party data provider's user domain. Such a mapping may have been previously generated and stored by the online advertisement service provider and may be used to map identifiers from one user domain to another. Data aggregator 218 may be further configured to receive results of the queries and provide the results to quality assessment metric generator 220 and data storage system 210 and database system 212 as well.

Data analyzer 216 may also include quality assessment metric generator 220 which may be configured to generate quality assessment metrics that characterize a quality and accuracy of third party data provided by third party data provider 228. As will be discussed in greater detail below, quality assessment metric generator 220 may be configured to generate probability metrics which may characterize a quality and accuracy of each value of each data category included in the third party data and identified by the third party data provider. As will be discussed in greater detail below, at least some of the probability metrics may be combined to generate the quality assessment metrics. In various embodiments, quality assessment metric generator 220 may be further configured to generate price recommendations and third party data provider recommendations based on the probability metrics and quality assessment metrics. Accordingly, data analyzer 216 may be configured to generate and provide recommendations to an online advertiser. The recommendations may identify prices associated with access to the third party data as well as an overall cost efficiency of each third party data provider. Such recommendations may be specific to a particular set of targeting criteria provided by the advertiser.

In various embodiments, data analyzer 216 or any of its respective components may include one or more processing devices configured to process data records received from various data sources. In some embodiments, data analyzer 216 may include one or more communications interfaces configured to communicatively couple data analyzer 216 to other components and entities, such as a data storage system and a record synchronizer. Furthermore, as similarly stated above, data analyzer 216 may include one or more processing devices specifically configured to process audience profile data associated with data events, online users, and websites. In one example, data analyzer 216 may include several processing nodes, specifically configured to handle processing operations on large data sets. For example, data analyzer 216 may include a first processing node configured as data aggregator 218, and a second processing node configured as quality assessment metric generator 220. In another example, data aggregator 218 may include big data processing nodes for processing large amounts of performance data in a distributed manner. In one specific embodiment, data analyzer 216 may include one or more application specific processors implemented in application specific integrated circuits (ASICs) that may be specifically configured to process large amounts of data in complex data sets, as may be found in the context referred to as “big data.”

In some embodiments, the one or more processors may be implemented in one or more reprogrammable logic devices, such as a field-programmable gate array (FPGAs), which may also be similarly configured. According to various embodiments, data analyzer 216 may include one or more dedicated processing units that include one or more hardware accelerators configured to perform pipelined data processing operations. For example, as discussed in greater detail below, operations associated with the generation of quality assessment metrics may be handled, at least in part, by one or more hardware accelerators included in quality assessment metric generator 220.

In various embodiments, such large data processing contexts may involve performance data stored across multiple servers implementing one or more redundancy mechanisms configured to provide fault tolerance for the performance data. In some embodiments, a MapReduce-based framework or model may be implemented to analyze and process the large data sets disclosed herein. Furthermore, various embodiments disclosed herein may also utilize other frameworks, such as .NET or grid computing.

In various embodiments, system 200 may include data storage system 210. In some embodiments, data storage system 210 may be implemented as a distributed file system. As similarly discussed above, in the context of processing online advertising data from the above described data sources, there may be many terabytes of log files generated every day. Accordingly, data storage system 210 may be implemented as a distributed file system configured to process such large amounts of data. In one example, data storage system 210 may be implemented as a Hadoop® Distributed File System (HDFS) that includes several Hadoop® clusters specifically configured for processing and computation of the received log files. For example, data storage system 210 may include two Hadoop® clusters where a first cluster is a primary cluster including one primary namenode, one standby namenode, one secondary namenode, one Jobtracker, and one standby Jobtracker. The second node may be utilized for recovery, backup, and time-costing query. Furthermore, data storage system 210 may be implemented in one or more data centers utilizing any suitable multiple redundancy and failover techniques.

In various embodiments, system 200 may also include database system 212 which may be configured to store data generated by data analyzer 216. In some embodiments, database system 212 may be implemented as one or more clusters having one or more nodes. For example, database system 212 may be implemented as a four-node RAC (Real Application Cluster). Two nodes may be configured to process system metadata, and two nodes may be configured to process various online advertisement data, which may be performance data, that may be utilized by data analyzer 216. In various embodiments, database system 212 may be implemented as a scalable database system which may be scaled up to accommodate the large quantities of online advertising data handled by system 200. Additional instances may be generated and added to database system 212 by making configuration changes, but no additional code changes.

In various embodiments, database system 212 may be communicatively coupled to console servers 214 which may be configured to execute one or more front-end applications. For example, console servers 214 may be configured to provide application program interface (API) based configuration of advertisements and various other advertisement campaign data objects. Accordingly, an advertiser may interact with and modify one or more advertisement campaign data objects via the console servers. In this way, specific configurations of advertisement campaigns may be received via console servers 214, stored in database system 212, and accessed by advertisement servers 208 which may also be communicatively coupled to database system 212. Moreover, console servers 214 may be configured to receive requests for analyses of performance data, and may be further configured to generate one or more messages that transmit such requests to other components of system 200.

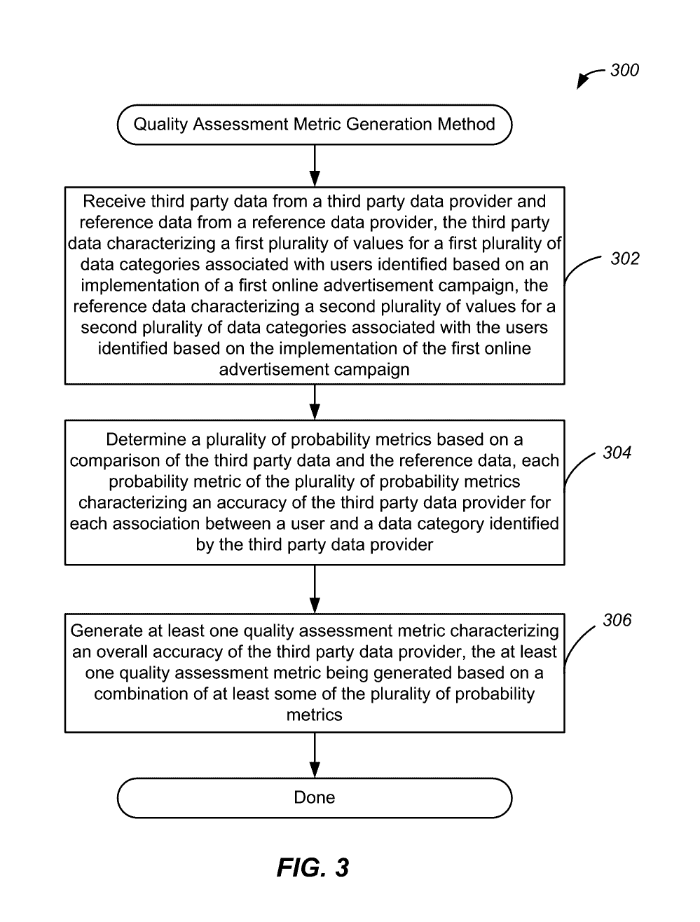

FIG. 3 illustrates a flow chart of an example of a quality assessment metric generation method, implemented in accordance with some embodiments. As disclosed herein, a method, such as method 300, may be implemented to generate a quality assessment metric that characterizes an overall quality and accuracy of data received from a third party data provider. Accordingly, method 300 may be implemented to provide an efficient and low-cost assessment of third party data. In some embodiments, an online advertisement campaign may be implemented to target users of various websites. Third party data and reference data may be collected for the users of the websites that have been targeted by the online advertisement campaign. Probability distributions of the collected third party data and reference data may be analyzed to determine an overall quality of the third party data with respect to the reference data. In various embodiments, method 300 may be implemented for numerous third party data providers. Accordingly, quality assessment metrics may be generated for several third party data providers to characterize a quality of each third party data provider, and to generate recommendations based on such quality assessment metrics.

Accordingly, method 300 may commence with operation 302 during which third party data may be received from a third party data provider, and reference data may be received from a reference data provider. As discussed above, a system component, such as one or more components of a data analyzer, may retrieve the third party data and reference data from third party data providers and reference data providers respectively. In some embodiments, the third party data and the reference data are associated with at least one online advertisement campaign. As will be discussed in greater detail below, one or more online advertisement campaigns may be configured and implemented to provide impressions to users of various websites, and generate data events associated with those users. Data characterizing one or more features of each user may be retrieved from each of the third party data providers and the reference data providers. As discussed in greater detail below, the features may be data categories that characterize other types of profile descriptive data, such as personal or professional interests, employment status, home ownership, knowledge of languages, age, education level, gender, race and/or ethnicity, income, marital status, religion, size of family, field of expertise, residential location (country, state, DMA, etc.), and travel location.

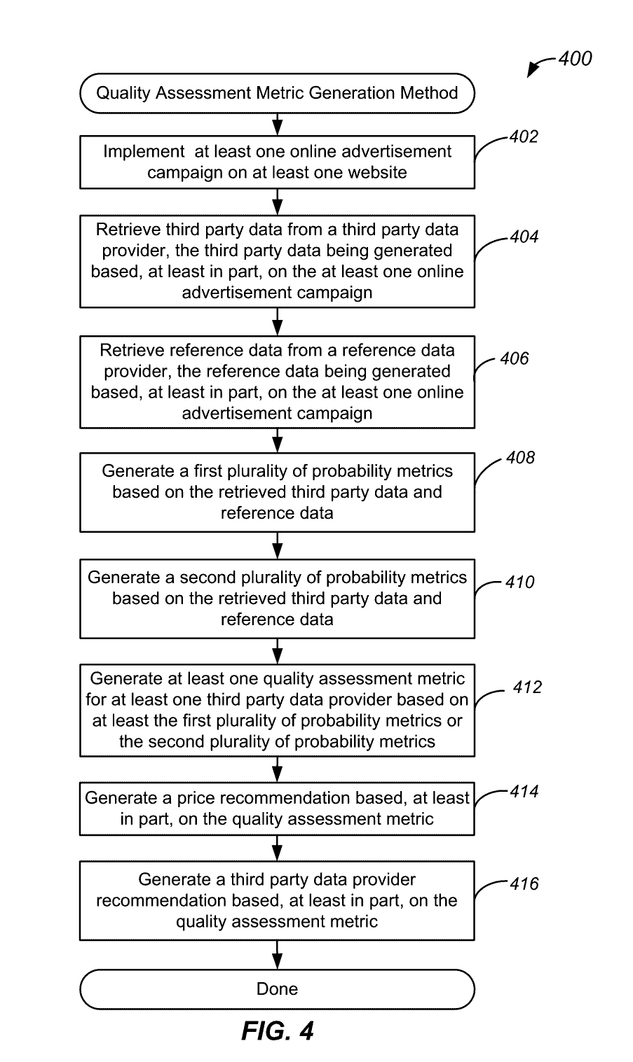

Accordingly, as will be discussed in greater detail below with reference to FIG. 4, the third party data and reference data may be generated based, at least in part, on online advertisement activity that resulted from the implementation of the one or more online advertisement campaigns. In various embodiments, the third party data may characterize the third party data providers' representations of audience profiles for the websites upon which the online advertisement campaign was implemented. Moreover, the reference data may characterize reference data providers' representations of audience profiles for the websites upon which the online advertisement campaign was implemented.

Method 300 may proceed to operation 304 during which a plurality of probability metrics may be determined based on a comparison of the third party data and the reference data, where each probability metric of the plurality of probability metrics characterizes an accuracy of the third party data provider for each value of a data category identified by the third party data provider. Accordingly, the probability metrics may represent an accuracy of a third party data provider with respect to the third party data provider's characterization of a particular feature of a user. As discussed above, third party data may identify users that were targeted by a website as well as values of data categories associated with each user, such as whether or not a user is a male or female, is a particular type of shopper, or belongs to a particular age group. As will be discussed in greater detail below, the probability metrics may be generated based on one or more identified differences between probabilities determined based on the third party data and the reference data. Moreover, the probability metrics may be generated based on several estimated conditional probabilities generated based on the third party data and the reference data. Accordingly, a probability metric may be generated for each value of each data category associated with each user. As will be discussed in greater detail below, each probability metric may be specific to a particular third party data provider.

Method 300 may proceed to operation 306 during which at least one quality assessment metric may be generated that characterizes an overall accuracy of the third party data provider. In some embodiments, the quality assessment metric may characterize an accuracy and a quality of a third party data provider's overall representation of an audience profile for a particular website. As will be discussed in greater detail below, the quality assessment metric may be determined based on a weighted combination of the differences that may have been determined during operation 304. Moreover, the quality assessment metric may be determined based on a combination of estimated conditional probabilities that may have been determined during operation 304. Accordingly, the quality assessment metric may represent an overall accuracy or quality of third party data received from a third party data provider for a particular website across all users and data categories associated with those users. Moreover, such quality assessment metrics may be calculated across multiple campaigns, over several units of time, and for many different third party data providers. In this way, a quality of several third party data providers may be determined.

FIG. 4 illustrates a flow chart of an example of another quality assessment metric generation method, implemented in accordance with some embodiments. As disclosed herein, a method, such as method 400, may be implemented to generate a quality assessment metric that characterizes an overall quality and accuracy of data received from a third party data provider. In some embodiments, an online advertisement campaign may be implemented to target users of various websites. Third party data and reference data may be collected for the users of the websites that have been targeted by the online advertisement campaign. Probability distributions of the collected third party data and reference data may be analyzed to determine an overall quality of the third party data with respect to the reference data. Moreover, such assessments of quality may be used to generate recommendations of third party data providers to be used for online advertisement campaigns as well as recommendations for pricing of such third party data.

Method 400 may commence with operation 402 during which at least one online advertisement campaign may be implemented. As similarly discussed above, an online advertisement campaign may be implemented across many websites to target many different users. In various embodiments, the online advertisement campaign may be configured based on several targeting criteria. The targeting criteria may be selected or configured to target a large number of users while not being affected or biased by one or more characteristics of a third party data provider. For example, targeting criteria may include a geographical region because such criteria are based on Internet Protocol (IP) addresses and are not based on third party data provider determinations, such as identifications of data categories. In another example, targeting criteria that target a particular age group, such as middle-age men as identified by a third party data provider, might not be implemented because the third party data provider has made the determination of the users' age group, and such a determination would bias the subsequent analysis of the data. In some embodiments, the targeting criteria might only include users' geographical location to target a wide range of users. Furthermore websites upon which the online advertisement campaign is implemented may be selected based on additional criteria, such as an expected or initial target audience of a website. In various embodiments, websites may be selected if they are known or designed to target a particular group of users. In one example, a website may be selected if 70% visitors are female and 30% visitors are male, and might not be selected if 50% visitors are female and 50% visitors are male. Such expected or initial target audiences may be determined based on independent surveys and/or correlation with offline behavior such as purchase histories. Selecting websites in this way ensures that sufficient data is collected for users having particular values of data categories. Once the one or more online advertisement campaigns have been configured and the websites have been selected, the one or more online advertisement campaigns may be run and data may be collected over a designated period of time. For example, an online advertisement campaign may be run for a period of a month and data may be collected for various users over the duration of the month.

Method 400 may proceed to operation 404 during which third party data may be retrieved from a third party data provider. As discussed above, a third party data provider may be a consumer data collection entity such as DataLogix, Bluekai, and Lotame. In various embodiments, the third party data may be generated based, at least in part, on the at least one online advertisement campaign implemented during operation 402. More specifically, the users identified by data events generated during the implementation of the at least one online advertisement campaign may form the basis of identifying and retrieving the third party data. For example, each data event may include a user identifier that identifies a user associated with the data event. The user identifier may be converted or mapped to a provider user domain to generate a provider user identifier. The provider user identifier may be sent to the third party data provider and the third party data provider may return all third party data that the third party data provider has stored for that particular user. Such data retrieval may be performed for each user and each third party data provider being assessed by method 400. In various embodiments, such querying of the third party data provider may be performed as an ongoing process during the implementation of the at least one online advertisement campaign or may be performed as one query at the end of the implementation of the at least one online advertisement campaign. In some embodiments, the data events may further identify, via website identifiers, which website was utilized to generate the data event for that user. In this way, the third party data that is retrieved may be correlated with user identifiers and website identifiers to generate a first plurality of audience profiles for the websites that were used to implement the online advertisement campaign. Accordingly, the first plurality of audience profiles may characterize the third party data providers' representations of audience populations of the selected websites.

Method 400 may proceed to operation 406 during which reference data may be retrieved from a reference data provider. The reference data may be generated based, at least in part, on the at least one online advertisement campaign. As similarly discussed above, data events generated by the implementation of the online advertisement campaign may identify several users, and user identifiers associated with those users may be sent to a reference data provider. The reference data provider may provide all data available to the reference data provider about the identified users. As discussed above, the reference data provider may have access to different data sources, such as offline financial information. Moreover, the reference data provider may have access to various online social network accounts associated with users, such as Facebook®, any may obtain data categories, such as age and gender, from such accounts. Accordingly, the reference data may identify values and data categories associated with the users that may be aggregated from offline and online data sources available to the reference data provider, but not the third party data provider. As similarly discussed above, the reference data may be correlated with user identifiers and website identifiers to generate a second plurality of audience profiles for the websites that were used to implement the online advertisement campaign. The second plurality of audience profiles may characterize the reference data providers' representations of audience populations of the selected websites.

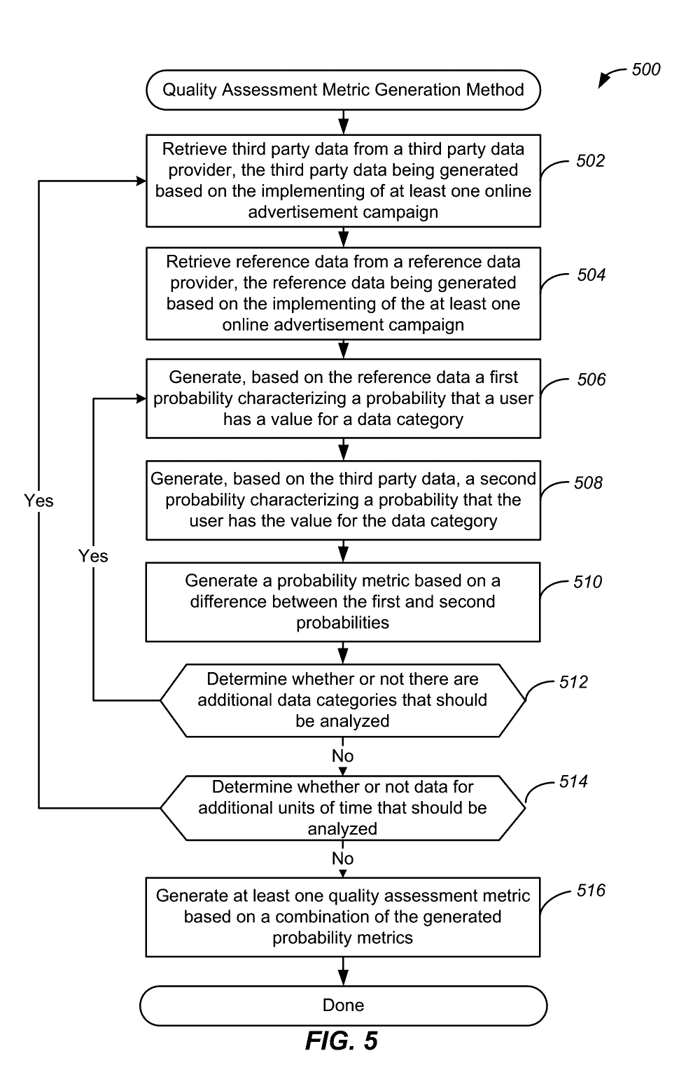

Method 400 may proceed to operation 408 during which a first plurality of probability metrics may be generated based on the retrieved third party data and reference data. As will be discussed in greater detail below with reference to FIG. 5, the first plurality of probability metrics may be generated based on one or more differences in probability distributions of the third party data and the reference data. In some embodiments, for each value of each data category, third party data and reference data may be analyzed. Moreover, the analysis may be partitioned by unit of time as well. For example, data may be analyzed for each day data was collected over a period of a month. A system component, such as a quality assessment metric generator, may determine a first probability that characterizes a probability that a user has a particular value for a particular data category based on the reference data. As will be discussed in greater detail below, the first probability may be calculated by analyzing the reference data and determining a first number of users that have a particular value for the data category, and then dividing the first number by a second number of users that identifies a number of users having any value for the data category. Similarly, a second probability may be calculated that characterizes a probability that a user has the particular value for the data category based on the third party data. As discussed above and in greater detail below, the second probability may be calculated by analyzing the third party data and determining a first number of users that have a particular value for the data category, and then dividing the first number by a second number of users that identifies a number of users having any value for the data category. A probability metric may be determined for that particular value of that data category by determining a difference between the first probability and the second probability.

As discussed in greater detail below with reference to FIG. 5, such a probability metric may be determined for each value of each data category represented in the third party data to generate the first plurality of probability metrics. In various embodiments, multiple campaigns are implemented during operation 402 across multiple units of time, which may be days. Accordingly, probability metrics may be determined for each value of each data category, per campaign, per unit of time. In various embodiments, probability metrics may be averaged across campaigns and units of time to generate a single probability metric for each value of each data category. When averaged in this way, the averaged probability metrics may be the first plurality of probability metrics.

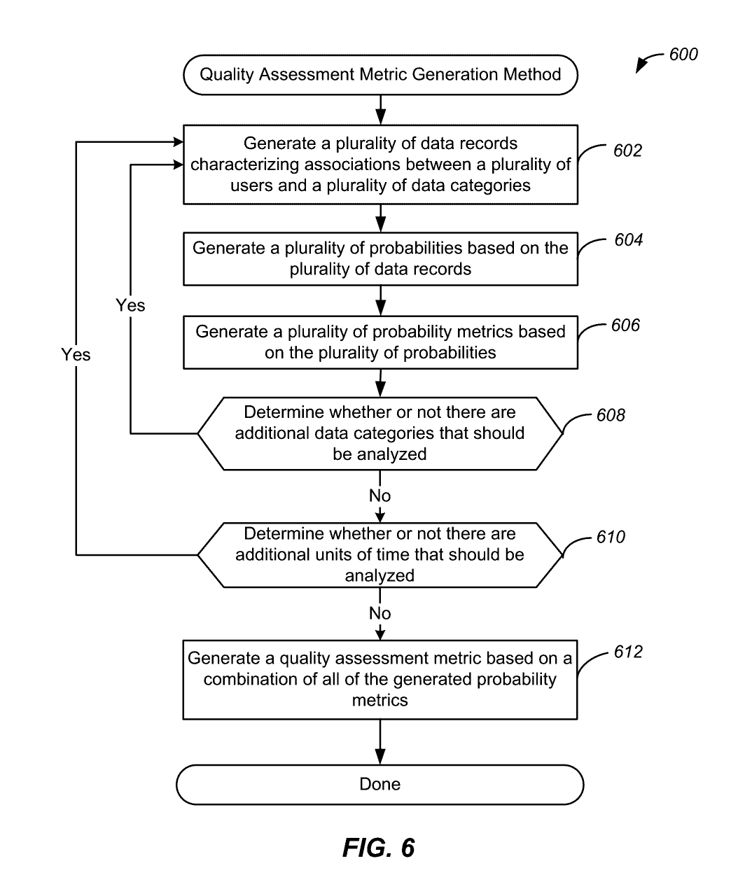

Method 400 may proceed to operation 410 during which a second plurality of probability metrics may be generated based on the retrieved third party data and reference data. As will be discussed in greater detail below with reference to FIG. 6, for each value of each data category represented in the third party data for a third party data provider, a plurality of conditional probabilities may be determined to identify a probability that, given that the third party data provider has identified a user as having a particular value for a particular data category, the user actually does not have that particular value. As discussed in greater detail below, such a determination may be made based on a solution of a system equations determined based on the retrieved reference data and third party data. Such an estimated conditional probability may be determined for each value of each data category represented in the third party data to generate the second plurality of probability metrics. As similarly discussed above, multiple campaigns may be implemented and analyzed over several units of time. Accordingly, the probability metrics determined for the various campaigns and units of time may be averaged together for each data category to generate the second plurality of metrics.

In various embodiments, operation 408 and operation 410 may be optionally performed. For example, operation 408 might be implemented and operation 410 might not be implemented. Alternatively, operation 410 might be implemented and operation 408 might not be implemented. In this way, either operation 408 or operation 410 may be implemented to generate either the first plurality of probability metrics or the second plurality of metrics during the implementation of method 400. Thus, according to some embodiments, either the first plurality of probability metrics or the second plurality of metrics may be subsequently processed during operation 412 described in greater detail below.

Accordingly, method 400 may proceed to operation 412 during which at least one quality assessment metric may be generated for at least one third party data provider based on at least the first plurality of probability metrics or the second plurality of probability metrics. In various embodiments, the quality assessment metric may be determined based on a combination of several probability metrics. For example, as will be discussed in greater detail below with reference to FIG. 5, the quality assessment metric may be a weighted sum or average of the first plurality of probability metrics. In another example, as will be discussed in greater detail below with reference to FIG. 6, the quality assessment metric may be a weighted sum or average of the second plurality of probability metrics. In this way, as will be discussed in greater detail below with reference to FIG. 5 and FIG. 6, an overall metric or score may be generated that provides an overall indication of how accurate the third party data is and how close its probability distribution is to the reference data.

Method 400 may proceed to operation 414 during which a price recommendation may be generated based, at least in part, on the at least one quality assessment metric. In various embodiments, the price recommendation may characterize a price charged by an online advertisement service provider for access to the third party data. In various embodiments, access to the third party data may be requested by an advertiser that subscribes to the services provided by the online advertisement service provider. For example, when utilizing the online advertisement service provider's services and platform to implement an online advertisement campaign, an advertiser may request audience profile data about candidate websites that may be selected and used to implement the online advertisement campaign. In various embodiments, the audience profile data may include third party data received from at least one third party data provider. Accordingly, the online advertisement service provider that manages the third party data may charge the advertiser a price to access and utilize the third party data.

In various embodiments, a price recommendation may be generated that determines a price for access to third party data based on an error rate associated with the third party data. Accordingly, the price recommendation may be higher for third party data having a higher quality and lower error rate, and the price recommendation may be lower for third party data having a lower quality and higher error rate. In some embodiments, the price recommendation may be determined based on equations 1 and 2 shown below:

F=Σ_{j∈V}Σᵢwᵢⱼ*Sᵢⱼ (1)

(G−F)*CPM>=Cost (2)

As shown in equation 1 above, F may be an average error rate for a particular third party data provider for a particular combination of values of data categories determined based on the implementation of the at least one online advertisement campaign discussed above with reference to operation 402. As shown in equation 2, G may be a probability that a random user does not have a particular value of a data category. Thus, G may identify a probability that an online advertisement campaign may incorrectly target a user if no third party data is used and users are targeted randomly. In various embodiments, G may be determined based on the reference data. For example G may be determined by analyzing the reference data to determining a first number that identifies a number of users that do not have a particular value for a data category, and by dividing the first number by a second number representing a total number of users. Accordingly, (G−F) may represent an improvement in an error rate provided by access to the third party data. Cost, may be the recommended price that is to be determined for the third party data. CPM may be a cost per quantity, such as a thousand, of impressions that an advertiser pays the websites for placing advertisements on those websites. Accordingly, (G−F)*CPM may identify a reduction in overall cost of implementing the online advertisement campaign that results from the user of the third party data. As shown in equation 2, a recommended price is determined such that the recommended price is not more than the reduction in overall cost. Thus, Cost, which is a price recommendation for the third party data, may be less than or equal to (G−F)*CPM. Determining the price recommendation in this way ensures that the price recommendation identifies a price that is less than randomly targeting users as may be the case when no third party data is used. In some embodiments, the price recommendation may be a determined to be a designated amount less than the identified reduction in cost represented by (G−F)*CPM. For example, the price recommendation may be 10% less than the identified reduction in cost. The price recommendation may also be a designated dollar amount or a designated amount per impression.

Method 400 may proceed to operation 416 during which a third party data provider recommendation may be generated based, at least in part, on the quality assessment metric.

In various embodiments, the third party data provider recommendation may characterize costs associated with using third party data from a particular third party data provider. In some embodiments, the costs associated with using third party data may be determined based on equation 3 shown below:

C=F*CPM+Cost (3)

As discussed above, F may be an average error rate for a particular third party data provider for a particular combination of values of data categories, CPM may be a cost per quantity, such as a thousand, of impressions that an advertiser pays the websites for placing advertisements on those websites, and Cost may be a price paid for access to the third party data. Accordingly, C may identify a total cost for using third party data from a particular third party data provider. In various embodiments, C may be calculated for each third party data provider being considered by the advertiser for implementation of an online advertisement campaign. Thus, multiple values of C may be calculated for multiple third party data providers. The third party data providers may be sorted and ranked based their respective values of C, and a third party data provider recommendation may be generated based on the ranking For example, the third party data provider recommendation may identify the third party data provider having the lowest or smallest value of C corresponding to a lowest or smallest total cost. In another example, several third party data providers may be identified that have a designated number of lowest or smallest values of C. In this example, the third party data providers that have the 5 smallest values of C may be identified. Alternatively, the third party data providers that have the 10 smallest values of C may be identified. In this way, an advertiser may be presented with a recommendation of a third party data provider to use that will provide a reduced cost to the advertiser. Moreover, the recommendation may be specific to the advertiser's targeting criteria for the advertiser's online advertisement campaign.

In various embodiments, recommendations may characterize or identify third party data providers that have a reduced or lower cost for implementation of an online advertisement campaign. In some embodiments, targeting criteria may be received from an advertiser. The targeting criteria may be designated or user-specified values of data categories used to target the online advertisement campaign. For example, the targeting criteria may designate males should be targeted by a particular online advertisement campaign to be implemented. One or more system components may use the calculated error rates and calculated costs to identify third party data providers that have lower calculated costs. In this way, the recommendation and selection of third party data providers may be performed based on targeting criteria received from an advertiser. Moreover, based on the received targeting criteria and third party data provider recommendations, one or more system components may be configured to generate a forecast that characterizes an estimate of an overall cost of implementing the online advertisement campaign. Accordingly, in response to receiving several targeting criteria, one or more forecasts may be generated that include a third party data provider recommendation and/or an estimate of a total cost of implementing the online advertisement campaign associated with the targeting criteria.

FIG. 5 illustrates a flow chart of an example of yet another quality assessment metric generation method, implemented in accordance with some embodiments. As disclosed herein, a method, such as method 500, may be implemented to generate a quality assessment metric that characterizes an overall quality and accuracy of data received from a third party data provider. Accordingly, method 500 may be implemented to analyze probability distributions of collected third party data and reference data, and to determine an overall quality of the third party data with respect to the reference data. As described in greater detail below, the analysis may include identifying and quantifying differences between probability distributions of the third party data and the reference data. In various embodiments, method 500 may be implemented for numerous third party data providers. Accordingly, quality assessment metrics may be generated for several third party data providers to characterize a quality of each third party data provider.

Method 500 may commence with operation 502 during which third party data may be retrieved from a third party data provider. As discussed above, the third party data may have been generated based on the implementing of at least one online advertisement campaign. In various embodiments, the third party data may be generated based, at least in part, on the at least one online advertisement campaign that was previously implemented. More specifically, the users identified by data events generated during the implementation of the at least one online advertisement campaign may form the basis of identifying and retrieving the third party data. For example, each data event may include a user identifier that identifies a user associated with the data event. The user identifier may be converted or mapped to a provider user domain to generate a provider user identifier. The provider user identifier may be sent to the third party data provider and the third party data provider may return all third party data that the third party data provider has stored for that particular user. Such data retrieval may be performed for each user and each third party data provider being assessed by method 500. In various embodiments, such querying of the third party data provider may be performed as an ongoing process during the implementation of the at least one online advertisement campaign or may be performed as one query at the end of the implementation of the at least one online advertisement campaign. In some embodiments, the data events may further identify, via website identifiers, which website was utilized to generate the data event for that user. In this way, the third party data that is retrieved may be correlated with user identifiers and website identifiers to generate a first plurality of audience profiles for the websites that were used to implement the online advertisement campaign. Accordingly, the first plurality of audience profiles may characterize the third party data providers' representations of audience populations of the selected websites.

Method 500 may proceed to operation 504 during which reference data may be retrieved from a reference data provider. As discussed above, the reference data may have been generated based on the implementing of the at least one online advertisement campaign. The reference data may be generated based, at least in part, on the at least one online advertisement campaign. As similarly discussed above, data events generated by the implementation of the online advertisement campaign may identify several users, and user identifiers associated with those users may be sent to a reference data provider. The reference data provider may provide all data available to the reference data provider about the identified users. As discussed above, the reference data provider may have access to different data sources, such as offline financial information and various online user accounts such as online social network accounts. Accordingly, the reference data may identify values and data categories associated with the users that may be aggregated from offline and online data sources available to the reference data provider, but not the third party data provider. As similarly discussed above, the reference data may be correlated with user identifiers and website identifiers to generate a second plurality of audience profiles for the websites that were used to implement the online advertisement campaign. The second plurality of audience profiles may characterize the reference data providers' representations of audience populations of the selected websites.

While operations 502 and 504 discussed above have been described as retrieving third party data from a third party data provider and retrieving reference data from a reference data provider, in various embodiments, such data may be retrieved from a data storage system based on a previous implementation of an online advertisement campaign. Accordingly, the at least one online advertisement campaign underlying the third party data and reference data may have been previously implemented, the underlying data may have been previously retrieved from data providers, and during operations 502 and 504, the data may be retrieved from a data storage system.

Method 500 may proceed to operation 506 during which a first probability may be generated based on the reference data. The first probability may characterize a probability that a user has a value for a data category. As discussed above, a data category may be a feature or characteristic associated with a user. Moreover, one or more data values may be stored that identify the user's association with the data category. For example, if the data category is “gender,” a value of “male” may be stored if the user is male and a value of “female” may be stored if the user is female. In this way, data structures, such as vectors, may store data values characterizing features or data categories of a user. In various embodiments, the first probability may be determined by determining a first number of users that has a particular value for the data category being analyzed. The first number of users may be divided by a second number of users that have any value for the data category. For example, a probability that a user has a value of “male” denoted P₁(male), may be determined by determining a first number of users that were served impressions and are labeled, by the reference data provider, as male. The first number may be divided by a second number of users that were provided impressions and have any value of the data category being analyzed. For the data category gender, the second number may identify users that are labeled, by the reference data provider, as female or male. As will be discussed in greater detail below, the data may be analyzed per unit of time, such as a day. Accordingly, such probabilities may be determined for each day for which data has been recorded. Moreover, such probabilities may be determined for each value of each data category. For example, another probability denoted P₁(female) may also be calculated by dividing a number of users that were served impressions and are labeled as female by a number of users that were served impressions and are labeled as female or male. In this way, a first probability may be determined for each possible value of each data category as identified based on the reference data.

Method 500 may proceed to operation 508 during which a second probability may be generated based on the third party data. The second probability may characterize a probability that a user is associated with a data category. As similarly discussed above, the second probability may be determined by determining a first number of users that has a particular value for the data category being analyzed, and dividing the first number by a second number of users that have any value for the data category. In contrast to operation 506, during operation 508 the second probabilities are determined based on the third party data and not the reference data. Accordingly, a probability that a user has a value of “male” denoted P₂(male), may be determined by dividing a first number of users that were served impressions and are labeled, by the third party data provider, as male by a second number of users that were provided impressions and are labeled, by the third party data provider, as female or male. As stated above, the data may be analyzed per unit of time, such as a day, and such probabilities may be determined for each day for which data has been recorded. As similarly stated above, the second probabilities may be calculated for each value of each data category. For example, another probability denoted P₂(female) may also be calculated by dividing a number of users that were served impressions and are labeled as female by a number of users that were served impressions and are labeled as female or male. In this way, a second probability may also be determined for each possible value of each data category as identified by the third party data.

Method 500 may proceed to operation 510 during which a probability metric may be generated based on a difference between the first and second probabilities. In some embodiments, the probability metric may be determined by calculating an absolute difference between the first probability and the second probability. In various embodiments, the difference in probabilities represents a difference between a probability distribution of values recorded by the third party data provider and a probability distribution of values recorded by the reference data provider. Thus, the probability metric may use the reference data as a baseline or “gold standard,” and may characterize a third party data provider's deviation or difference from that baseline. In this way, the probability metric may identify and characterize a relative accuracy of the third party data with respect to the reference data. In some embodiments, an absolute difference may be determined using equation 4 shown below:

S=|P₁−P₂| (4)

In one example, for a value of “male” for a data category “gender”, a probability metric or score denoted S(male) may be determined by calculating the absolute difference between P₁(male) and P₂(male). Accordingly, S(male) may be determined based on equation 5 shown below:

S(male)=|P₁(male)−P₂(male)| (5)

In some embodiments, the probability metric may be determined by calculating a relative absolute difference as may be determined based on equation 6 or equation 7 shown below:

S=|P₁−P₂|/P₁ (6)

S=|P₁−P₂|/P₂ (7)

While one example of a value of a data category has been illustrated, similar determinations may also be made for any other value of any other data category. In this way, a probability metric may be determined for any and/or all values of data categories represented in the third party data. As will be discussed in greater detail below, probability metrics may be determined for all values of all data categories represented in the third party data, and a quality assessment metric may be determined based on a combination of the probability metrics.

Method 500 may proceed to operation 512 during which it may be determined whether or not there are additional data categories that should be analyzed. In various embodiments, a system component, such as a data analyzer, may be configured to generate a list of data categories. The list may be generated based on previously received third party data, reference data, and advertisers. Accordingly, the list may be generated based on a combination of previously received data that has been aggregated over time. The data analyzer may iteratively step through each data category included in the list. Accordingly, the determination of whether or not additional data categories exist may be made based on a current list position of the data category currently being analyzed. If method 500 has arrived at the end of the list, it may be determined that there are no additional data categories. However, if method 500 is not at the end of the list, it may be determined that there are additional data categories. If it is determined that there are additional data categories that should be analyzed, method 500 may return to operation 506 and a different data category may be analyzed. If it is determined that there are no additional data categories that should be analyzed, method 500 may proceed to operation 514.

Method 500 may proceed to operation 514 during which it may be determined whether or not there is data for additional units of time that should be analyzed. In various embodiments, a system component, such as the data analyzer, may be configured to generate a list of data structures representing units of time for which data was received. For example, within a period of time, such as a month day, data may be collected and stored in several data objects each representing a unit of time, such as a day. Accordingly, the data analyzer may generate a list of such data structures to monitor and record the receiving of data. The data analyzer may iteratively step through each data structure identified by the list. Accordingly, the determination of whether or not additional units of time exist may be made based on a current list position of the data structure representing a unit of time currently being analyzed. If method 500 has arrived at the end of the list, it may be determined that there are no additional units of time. However, if method 500 is not at the end of the list, it may be determined that there are additional units of time. If it is determined that there is data for additional units of time that should be analyzed, method 500 may return to operation 502 and data for a different unit of time may be analyzed. In some embodiments, the different unit of time may be a succeeding unit of time. If it is determined that there are no additional units of time that should be analyzed, method 500 may proceed to operation 516.

Method 500 may proceed to operation 516 during which at least one quality assessment metric may be generated based on a combination of the generated probability metrics. In some embodiments, the quality assessment metric may be determined by calculating a weighted sum of all of the previously determined probability metrics. Accordingly, for a particular third party data provider, a sum may be determined for all probability metrics for all values of all data categories across all online advertisement campaigns and across all units of time may. In this way, the quality assessment metric may represent an overall metric of accuracy and quality of the third party data relative to the reference data. As discussed above with reference to FIG. 4, such a quality assessment metric may be used to generate various recommendations that may be used when implementing an online advertisement campaign. In various embodiments, the sum may be a weighted sum in which a weight w is calculated for each value of each data category. For example, a weight sum may be calculated based on equation 8 shown below:

Σᵢⱼwᵢⱼ*S(P₁ᵢⱼ,P₂ᵢⱼ) (8)

In some embodiments, the weight may be calculated based on equation 9 shown below:

wᵢⱼ=1/(n*k) (9)

As shown in equation 9, n may be the number of total values possible for a data category, and k may be the total number of units of time over which the online advertisement campaign was implemented. In various embodiments, the weights may be further weighted based on one or more designated values or data categories; for example, data categories or particular values of data categories may be selected as more important and may be given greater weight as may be determined by a designated coefficient. For example, the weights for values of the data category “gender” may be twice the weights for values for the data category “number of children”.

In various embodiments, third party data from multiple third party data providers may be analyzed as described above with reference to method 500 while using a single initial implementation of an online advertisement campaign, as previously discussed with reference to operation 402 of FIG. 4. As discussed above, all data associated with a user may have been retrieved and stored while the online advertisement campaign was running Accordingly, third party data may already be stored in a data storage system operated and maintained by the online advertisement service provider. Such previously stored data may be retrieved at operations 502 and 504, and method 500 may be implemented as described above.

FIG. 6 illustrates a flow chart of an example of another quality assessment metric generation method, implemented in accordance with some embodiments. As disclosed herein, a method, such as method 600, may be implemented to generate a quality assessment metric that characterizes an overall quality and accuracy of data received from a third party data provider. Accordingly, method 600 may be implemented to analyze probability distributions of collected third party data and reference data, and to determine an overall quality of the third party data with respect to the reference data. As described in greater detail below, the analysis may include estimating a conditional probability associated with a third party data provider based on the available data. In various embodiments, method 600 may be implemented for numerous third party data providers. Accordingly, quality assessment metrics may be generated for several third party data providers to characterize a quality of each third party data provider.

Method 600 may commence with operation 602 during which a plurality of data records may be generated that characterize at least one third party data provider's representation of values for data categories associated with a plurality of users. In various embodiments, the data records may be reports that characterize numbers of users that may be included in one or more categories. More specifically, several data records including reports may be generated that describe a number of users having an identified relationship with a value of a data category. The reported identified relationships may be configured to identify a particular value for a data category, and further identify a number of users that have that value, as may be determined by the third party data provider and/or reference data provider. As will be discussed in greater detail below, such reports included in data records may form the underlying data objects upon which probability metrics are determined. For example, for a particular value j, the data records may include a first report S₁ that identifies the number of users that the third party data provider has identified as having the value j. The data records may also include a second report S₂ that identifies the number of users that the third party data provider has identified as not having the value j. The data records may further include a third report S₃ that identifies the number of users that the third party data provider has no information for. In some embodiments, the data records may include a fourth report S₄ that identifies the number of users that the reference data provider has identified as having value j. The data records may also include a fifth report S₅ that identifies the number of users that the reference data provider has identified as not having value j. The data records may additionally include a sixth report S₆ that identifies the number of users that the reference data provider has no data for. As will be discussed in greater detail below, such reports may be generated for each value of each data category.

Method 600 may proceed to operation 604 during which a plurality of probabilities may be generated based on the plurality of data records. In various embodiments, a system of equations may be used in conjunction with the data records to estimate several different conditional probabilities. Estimating conditional probabilities in this way enables an online advertisement service provider to estimate conditional probabilities for a given set of target criteria. Thus, a set of target criteria may be received from an advertiser for an online advertisement campaign to be implemented. Such an online advertisement campaign may be different than the online advertisement campaign that may have been previously implemented, as discussed above with reference to operation 402 of FIG. 4. Accordingly, based on the target criteria received from the advertiser, data records including reports may be generated based on previously stored data, and estimates of conditional probabilities may be generated as part of a forecast for the online advertisement campaign that the advertiser intends to implement. Thus, estimated conditional probabilities as disclosed herein may be implemented to forecast and predict at least one quality assessment metric for at least one third party data provider that may provide data used to implement the online advertisement campaign. In this way, quality assessment metrics may be generated dynamically for third party data providers based on targeting criteria received from advertisers and without the implementation of the online advertisement campaign associated with the received targeting criteria. As discussed in greater detail below, several expressions of conditional probabilities may be generated that may subsequently be used in conjunction with the data records to solve for several estimated conditional probabilities.

In various embodiments, the conditional probabilities may include a first probability P₁ that represents the probability that a user is identified by the reference data provider as having value j given that the user has been identified as having value j by the third party data provider. The conditional probabilities may also include a second probability P₂ that represents the probability that a user is identified by the reference data provider as having value j given that the user has been identified as not having value j by the third party data provider. The conditional probabilities may further include a third probability P₃ that represents the probability that a user is identified by the reference data provider as having value j given that the third party has no data about the user.

In some embodiments, the conditional probabilities may include a fourth probability P₄ that represents the probability that a user is identified by the reference data provider as not having value j given that the user has been identified as having value j by the third party data provider. The conditional probabilities may also include a fifth probability P₅ that represents the probability that a user is identified by the reference data provider as not having value j given that the user has been identified as not having value j by the third party data provider. The conditional probabilities may further include a sixth probability P₆ that represents the probability that a user is identified by the reference data provider as not having value j given that the third party data provider has not data about the user.

In various embodiments, the conditional probabilities may include a seventh probability P₇ that represents the probability that the reference data provider has no data about a user given that the user has been identified as having value j by the third party data provider. The conditional probabilities may also include an eighth P₈ that represents the probability that the reference data provider has no data about a user given that the user has been identified as not having value j by the third party data provider. The conditional probabilities may further include a ninth probability P₉ that represents the probability that the reference data provider has no data about a user given that the third party data provider has no data about the user.

The previously described data records and expressions of conditional probabilities may be used to determine the conditional probabilities themselves. For example, the conditional probabilities may be determined based on equation 10 shown below:

Min_{P}_{_{1,}}_{P}_{_{2,}}_{P}_{_{3,}}_{P}_{₄}_{,P}_{_{5,}}_{P}_{_{6,}}_{P}_{_{7,}}_{P}_{_{8,}}_{P}_{₉}(S₄−S₁*P₁−S₂*P₂−S₃*P₃−*P₃)²+(S₅−S₁*P₄−S₂*P₅−S₃*P₆)²+(S₆−S₁*P₇−S₂*P₈−S₃P₉)² (10)

Where the following constraints shown by equations 11-16 apply:

0<=Pᵢ<=1, for i=1 . . . 9 (11)

P₁+P₄+P₇=1 (12)

P₂+P₅+P₈=1 (13)

P₃+P₆+P₉=1 (14)

α<P₁−P₅<β (15)

α<P₂−P₄<β (16)

In various embodiments, α and β are designated parameters that may be set by an online advertisement service provider. In one example, α=−0.1 and β=0.1. Equation 10 may be solved to determine an estimation of P₄. As will be discussed in greater detail below with reference to operation 606, P₄ may form the basis of generating a probability metric. As similarly discussed above, such estimations of conditional probabilities may be determined for multiple online advertisement campaigns across multiple units of time to generate a single estimated conditional probability for a particular value of a data category for a particular third party data provider.

In some embodiments, a linear system of equations may be used to determine the conditional probabilities. For example, the system of equations may include equations 17-25 shown below:

S₄=S₁*P₁−S₂*P₂−S₃*P₃ (17)

S₅=S₁*P₄−S₂*P₅−S₃*P₆ (18)

S₆=S₁*P₇−S₂*P₈−S₃*P₉ (19)

S₄′=S₁′*P₁−S₂′*P₂−S₃′*P₃ (20)

S₅′=S₁′*P₄−S₂′*P₅−S₃′*P₆ (21)

S₆′=S₁′*P₇−S₂′*P₈−S₃′*P₉ (22)

P₁+P₄+P₇=1 (23)

P₂+P₅+P₈=1 (24)

P₃+P₆+P₉=1 (25)

In equations 17-25 shown above, S₁, . . . , S₆ may be reports from a first online advertisement campaign, and S₁′, . . . , S₆′ may be reports from a second online advertisement campaign. Accordingly, for the nine variables and nine equations included in the linear system of equations shown above, a single solution may be determined and subsequently used to determine a probability metric, as described in greater detail below.

Method 600 may proceed to operation 606 during which a plurality of probability of plurality metrics may be generated based on the plurality of probabilities. In various embodiments, the probability metrics may be generated based on one of the probabilities generated during operation 604. For example, a probability metric may be the fourth probability. Accordingly, a probability metric may represent the probability that a user is identified by the reference data provider as not having value j given that the user has been identified as having value j by the third party data provider. As will be discussed in greater detail below, such probability metrics may be generated for all values of all data categories identified by the third party data. Moreover, such probability metrics may be calculated across multiple campaigns and averaged to generate a single probability metric for a particular value of a data category within a unit of time.

Method 600 may proceed to operation 608 during which it may be determined whether or not there are additional data categories that should be analyzed. As similarly discussed above, the determination of whether or not additional data categories exist may be made based on a current list position of the data category currently being analyzed. If method 600 has arrived at the end of a list of data categories, it may be determined that there are no additional data categories. However, if method 600 is not at the end of the list, it may be determined that there are additional data categories. If it is determined that there are additional data categories that should be analyzed, method 600 may return to operation 602. If it is determined that there are no additional data categories, method 600 may proceed to operation 610.

Method 600 may proceed to operation 610 during which it may be determined whether or not there are additional units of time that should be analyzed. As similarly discussed above, a data analyzer may generate a list of data structures corresponding to units of time for which data was collected, thus monitoring and recording the receiving of data. The data analyzer may iteratively step through each data structure identified by the list. Accordingly, the determination of whether or not additional units of time exist may be made based on a current list position of the data structure representing a unit of time currently being analyzed. If method 600 has arrived at the end of the list, it may be determined that there are no additional units of time. However, if method 600 is not at the end of the list, it may be determined that there are additional units of time. If it is determined that there are additional units of time that should be analyzed, method 600 may return to operation 602. If it is determined that there are no additional data categories, method 600 may proceed to operation 612.

Method 600 may proceed to operation 612 during which at least one quality assessment metric may be generated based on a combination of all of the generated probability metrics. In various embodiments, the quality assessment metric may be a weighted sum determined by previously described equations 8 and 9. Accordingly, the quality assessment metric may be determined by summing all of the probability metrics for a particular third party data provider. Moreover, the probability metrics may be weighted to normalize the probability metrics as well as apply any designated weighting coefficients which may have been previously specified by an entity, such as an advertiser, to identify a relative importance of one or more data categories. In this way, the quality assessment metric may be a combination of all probability metrics for a particular third party data provider across several online advertisement campaigns and several units of time.

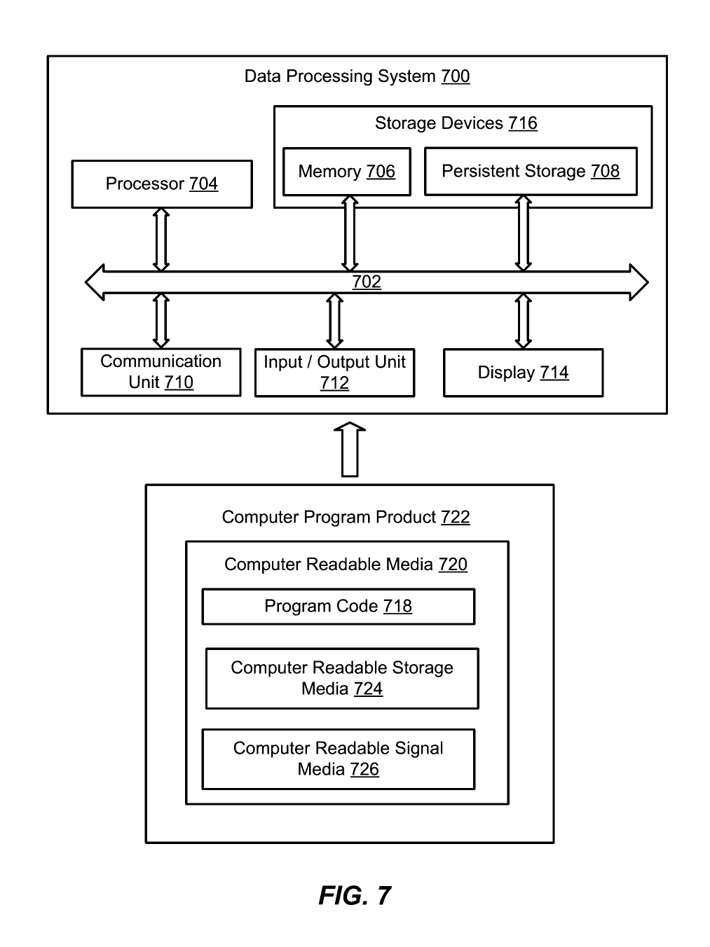

FIG. 7 illustrates a data processing system configured in accordance with some embodiments. Data processing system 700, also referred to herein as a computer system, may be used to implement one or more computers or processing devices used in a controller, server, or other components of systems described above, such as a quality assessment metric generator. In some embodiments, data processing system 700 includes communications framework 702, which provides communications between processor unit 704, memory 706, persistent storage 708, communications unit 710, input/output (I/O) unit 712, and display 714. In this example, communications framework 702 may take the form of a bus system.

Processor unit 704 serves to execute instructions for software that may be loaded into memory 706. Processor unit 704 may be a number of processors, as may be included in a multi-processor core. In various embodiments, processor unit 704 is specifically configured to process large amounts of data that may be involved when processing third party data and reference data associated with one or more advertisement campaigns, as discussed above. Thus, processor unit 704 may be an application specific processor that may be implemented as one or more application specific integrated circuits (ASICs) within a processing system. Such specific configuration of processor unit 704 may provide increased efficiency when processing the large amounts of data involved with the previously described systems, devices, and methods. Moreover, in some embodiments, processor unit 704 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these illustrative examples. Memory 706, in these examples, may be, for example, a random access memory or any other suitable volatile or non-volatile storage device. Persistent storage 708 may take various forms, depending on the particular implementation. For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications framework 702. The processes of the different embodiments may be performed by processor unit 704 using computer-implemented instructions, which may be located in a memory, such as memory 706.

These instructions are referred to as program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these illustrative examples. In one example, computer readable media 720 may be computer readable storage media 724 or computer readable signal media 726.

In these illustrative examples, computer readable storage media 724 is a physical or tangible storage device used to store program code 718 rather than a medium that propagates or transmits program code 718.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code 718.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a data aggregator configured to receive third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign; and
a quality assessment metric generator configured to determine a plurality of probability metrics based on a comparison of the third party data and the reference data, each probability metric of the plurality of probability metrics characterizing an accuracy of the third party data provider for each association between a user and a data category identified by the third party data provider, the quality assessment metric generator being further configured to generate at least one quality assessment metric characterizing an overall accuracy of the third party data provider, the at least one quality assessment metric being generated based on a combination of at least some of the plurality of probability metrics.

2. The system of claim 1, wherein the plurality of probability metrics include estimated conditional probabilities that each characterize a probability that a user is identified by the reference data provider as not having a value given that the user has been identified as having the value by the third party data provider.

3. The system of claim 2, wherein the plurality of probability metrics include an estimated conditional probability for each value of each data category included in the first plurality of data categories.

4. The system of claim 3, wherein the at least one quality assessment metric is a weighted sum of the plurality of probability metrics.

5. The system of claim 4, wherein the weighted sum includes a plurality of weights, wherein each weight of the plurality of weights is determined based on a number of possible values for each data category and a designated weight coefficient.

6. The system of claim 5, wherein the quality assessment metric generator is further configured to generate the plurality of probability metrics based on targeting criteria for a second online advertisement campaign, the second online advertisement campaign being different from the first online advertisement campaign.

7. The system of claim 1, wherein the quality assessment metric generator is configured to generate the plurality of probability metrics by identifying a plurality of differences between a first probability distribution of the third party data and a second probability distribution of the reference data.

8. The system of claim 7, wherein each probability metric of the plurality of probability metrics characterizes a difference between a probability associated with a value of a data category identified by the third party data provider and a probability associated with a value of a data category identified by the reference data provider, and wherein the at least one quality assessment metric is a weighted sum of the plurality of probability metrics.

9. The system of claim 1, wherein the quality assessment metric generator is further configured to:
generate a plurality of price recommendations based on the at least one quality assessment metric, the price recommendation identifying a recommended price associated with the third party data.

10. The system of claim 1, wherein the quality assessment metric generator is further configured to:
generate a third party data provider recommendation based on the at least one quality assessment metric, the third party data provider recommendation identifying a recommended third party data provider associated with a third online advertisement campaign.

11. A system comprising:
at least a first processing node configured to receive third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign; and
at least a second processing node configured to determine a plurality of probability metrics based on a comparison of the third party data and the reference data, each probability metric of the plurality of probability metrics characterizing an accuracy of the third party data provider for each association between a user and a data category identified by the third party data provider, the second processing node being further configured to generate at least one quality assessment metric characterizing an overall accuracy of the third party data provider, the at least one quality assessment metric being generated based on a combination of at least some of the plurality of probability metrics.

12. The system of claim 11, wherein the plurality of probability metrics include estimated conditional probabilities that each characterize a probability that a user is identified by the reference data provider as not having a value given that the user has been identified as having the value by the third party data provider.

13. The system of claim 12, wherein the plurality of probability metrics include an estimated conditional probability for each value of each data category included in the first plurality of data categories.

14. The system of claim 13, wherein the at least one quality assessment metric is a weighted sum of the plurality of probability metrics, wherein the weighted sum includes a plurality of weights, and wherein each weight of the plurality of weights is determined based on a number of possible values for each data category and a designated weight coefficient.

15. The system of claim 11, wherein the second processing node is configured to generate the plurality of probability metrics by identifying a plurality of differences between a first probability distribution of the third party data and a second probability distribution of the reference data.

16. The system of claim 15, wherein each probability metric of the plurality of probability metrics characterizes a difference between a probability associated with a value of a data category identified by the third party data provider and a probability associated with a value of a data category identified by the reference data provider, and wherein the at least one quality assessment metric is a weighted sum of the plurality of probability metrics.

17. One or more non-transitory computer readable media having instructions stored thereon for performing a method, the method comprising:
receiving third party data from a third party data provider and reference data from a reference data provider, the third party data characterizing a first plurality of values for a first plurality of data categories associated with users identified based on an implementation of a first online advertisement campaign, the reference data characterizing a second plurality of values for a second plurality of data categories associated with the users identified based on the implementation of the first online advertisement campaign;
determining a plurality of probability metrics based on a comparison of the third party data and the reference data, each probability metric of the plurality of probability metrics characterizing an accuracy of the third party data provider for each association between a user and a data category identified by the third party data provider; and
generating at least one quality assessment metric characterizing an overall accuracy of the third party data provider, the at least one quality assessment metric being generated based on a combination of at least some of the plurality of probability metrics.

18. The one or more non-transitory computer readable media of claim 17, wherein the plurality of probability metrics include estimated conditional probabilities that each characterize a probability that a user is identified by the reference data provider as not having a value given that the user has been identified as having the value by the third party data provider.

19. The one or more non-transitory computer readable media of claim 17, wherein the generating of the plurality of probability metrics further comprises:
identifying a plurality of differences between a first probability distribution of the third party data and a second probability distribution of the reference data.

20. The one or more non-transitory computer readable media of claim 17, wherein the method further comprises:
generating a plurality of price recommendations based on the at least one quality assessment metric, the price recommendation identifying a recommended price associated with the third party data; and
generating a third party data provider recommendation based on the at least one quality assessment metric, the third party data provider recommendation identifying a recommended third party data provider associated with a third online advertisement campaign.
